(19) United States
(12) Patent Application Publication
(10) Pub. No.: US 2013/0241779 A1
(43) Pub. Date: Sep. 19, 2013

(54) MULTI-RESONANCE ANTENNA, ANTENNA MODULE, RADIO DEVICE AND METHODS

(71) Applicant: Heikki Korva, Tupos (FI)

(72) Inventor: Heikki Korva, Tupos (FI)

(73) Assignee: Pulse Finland Oy, Kempele (FI)

(21) Appl. No.: 13/989,404

(22) PCT Filed: Jan. 12, 2012
(86) PCT No.: PCT/FI2012/050025

§ 371 Date: May 23, 2013

(30) Foreign Application Priority Data
Jan. 25, 2011 (FI) 20115072

(51) Int. Cl. H01Q 9/04

(52) U.S. Cl. CPC H01Q 9/04
USPC 343/700 MS

(57) ABSTRACT

An internal dual band antenna meant for small radio devices. In one embodiment, the antenna contains two radiators and a parasite element, which is shared between them. The parasite element is implemented on three sides of the antenna module, which are perpendicular to the side where the two radiators are implemented. The short-circuit conductor of the parasite element extends close to the supply point/points of the antenna on the circuit board of the radio device and is connected to the ground plane of the radio device. The antenna structure is dimensioned such that the two resonance frequencies on both functional bands are at a lower frequency than the resonance frequencies of the actual radiators. Accordingly, both the lower and upper frequency band is widened. The shape of the parasite element does not weaken the adaptation of the antenna in either functional band.

The invention relates to an antenna and an antenna module, which may be used to implement a multi-band antenna inside a radio device. The invention also relates to a radio device utilising the antenna module.

In small data processing devices, which also have a transmitter-receiver for connecting to a wireless data transfer network, such as in mobile phone models, PDA devices (Personal Digital Assistant) or portable computers, the antenna may be placed inside the cover of the data processing device.

The data processing device must often function in a system, where two or more frequency bands can be utilised, when necessary, which bands may be relatively far from each other. The utilised frequency bands may for example be in the frequency ranges 824-960 MHz and 1 710-2 170 MHz. These frequency bands are utilised for example in various mobile phone networks. The data processing device thus needs several antennae, so data transfer on different frequency bands can be handled. Supply to the antennae can be handled via a supply point, which is shared by the antennae, or alternatively each utilised antenna has its own antenna-specific supply point.

One solution for utilising two frequency bands in the same data processing device is to use two separate antenna arrangements, for example so that each frequency band has its own antenna in the device. Possible types of antennae to be utilised are half-wave antennae (two separate antennae) and various antennae utilising two resonance frequencies and IFA antennae (Inverted-F Antenna). In such antennae it is possible to utilise different passive (parasitic) antenna elements in determining the resonance locations on the antenna. In such antenna solutions the two frequency bands used by the data processing device may be formed and tuned independently from each other within certain limits.

Data transfer taking place on one frequency band must not disturb data transfer taking place on some other frequency band in the same data processing device. Therefore an antenna solution utilising one frequency band must attenuate the signals on the frequency band of another antenna solution by at least 12 dB.

It is however a disadvantage with two separate antenna arrangements that it is difficult to realise the space needed for both antennae in the data processing device. The parasite element required by the lower frequency band antenna has a large size, so the area/space remaining for the upper frequency band antenna element is small. In this situation the antenna of only one of the frequency bands can be optimised in a desired manner. Optimising both antennae on both frequency bands simultaneously requires an increase of about 20% in the surface area of the antenna arrangement. Additionally both the antennae must be supplied from their own supply point.

In WO 2006/070233 there is disclosed an antenna solution where one monopole antenna and a parasitic radiating element are utilized. The monopole antenna radiates its natural frequency and harmonic frequencies. The parasitic element radiates in two operating bands.

In EP 1432072 there is disclosed an antenna system having two monopole antennas and a parasitic element. Either the monopole antenna(s) or the parasitic element is a rigid wire or metal plate structure and is located over the other party.

In WO 2010/122220 there is disclosed an embodiment where a monopole antenna and a parasitic radiator are implemented on the cover structure of a mobile phone. The monopole antenna has resonance frequencies both in the lower and upper operating band and the parasitic radiator has a resonance in the upper operating band.

Adapting the antennae of the data processing device to the frequency bands to be used can also be done by utilising discrete components on the circuit board of the data processing device. This solution makes possible the utilisation of a shared supply point for both antennae being used. The adapting however typically requires five discrete components to be connected to the circuit board. Optimisation of two frequency ranges implemented with so many components is a difficult task. Especially if the adaptation circuits must be connected in connection with the actual antenna elements, the inductances of the used connectors also make the adaptation work of the antennae more difficult.

It is an object of the invention to provide a antenna for two frequency ranges, where both the upper and the lower frequency band has two resonance locations determined with mechanical sizing, which resonance locations increase on both frequency bands the bandwidth, which can be utilised by the data processing device.

It is an advantage of the invention that both the lower and the upper frequency band have resonance locations generated with both the actual antenna element and the parasite element. The locations of the resonance locations are determined with a coil determining the electric length of the radiators, the radiator of the parasite element and the lower frequency range. With the antenna solution according to the invention the usable bandwidth grows on both utilised frequency ranges.

It is additionally an advantage of the invention that the antenna adaptation in neither frequency range requires discrete components to be installed on the circuit board.

It is further and advantage of the invention that the antennae are adapted only with mechanical sizing of the partial components of the antenna arrangement and with their mutual positioning. Discrete components installed on the circuit board are not needed.

It is further an advantage of the invention that the parasite element comprised in the antenna arrangement affects the adaptation on the used frequency bands so little that it can be used as a visual element, so it can be shaped freely for example as a visual element of the data processing device.

It is further an advantage of the invention that the same parasite element is used both in the lower and the upper frequency range, whereby the antenna arrangement has a compact size.

It is further an advantage of the invention that due to properties of the parasite element, the hand of the user of the data processing device does in a use situation not substantially weaken the adaptation of the antennae.

It is further an advantage of the invention that the signals of an antenna utilising either of the frequency ranges are attenuated in the frequency range utilised by the antenna in a antenna arrangement with one supply point, where the upper and lower band are connected together, by at least 9 dB.

It is still an advantage of the invention that the same parasite element solution can be utilised both in antenna solutions with one supply point and with two separate supply points.

The antenna, antenna module and radio device according to the invention are characterised in what is presented in the independent claims.

Some advantageous embodiments of the invention are presented in the dependent claims.

The basic idea of the invention is the following: The antenna arrangement according to the invention comprises two antenna elements of monopole-type, which can be connected to a supply point, and one shared parasite element, which together provide two frequency bands to be utilised in the data processing device. The antenna arrangement according to the invention is implemented on the surface of a dielectric piece. The dielectric piece may for example be a rectangular polyhedron, whereby the antenna arrangement can be implemented on two or more surfaces of the rectangular polyhedron. The dielectric piece, on the surfaces of which the radiating elements and parasite element are manufactured, is called an antenna module. The antenna module is advantageously installed in one end of the circuit board of the data processing device, so that the ground plane of the circuit board of the data processing device does not extend to the part of the circuit board, which is left underneath the antenna module installed in its place. The active antenna elements are placed on the surface or face of the dielectric piece (antenna module), which will not be against the circuit board. The two antenna elements of the antenna arrangement may either have a shared supply point/antenna port or both antenna elements may have their own separate supply point/antenna port on the surface of the polyhedron.

The parasite element of the antenna arrangement is advantageously a U-shaped conductor strip, which in the case of a dielectric polyhedron is on three sides of the polyhedron, which are perpendicular to the plane of the circuit board. The ends of the U of the parasite element point toward the ground plane of the circuit board of the data processing device, however without reaching it. When the antenna module is installed on the circuit board, the “bottom” of the U extends close to the end of the circuit board, where the antenna module is attached.

The parasite element is connected to the ground plane of the data processing device with one conductive strip, which is at the level of the circuit board and in the direction of the longitudinal axis of the circuit board. The short-circuiting conductive strip of the parasitic element is connected to the ground plane of the circuit board at a point, which is close to the supply point/points of the antenna elements on the opposite side of the antenna module, when examined at the level of the circuit board. The connecting point between said conductive strip and the parasite element divides the parasite element into two parts, a lower frequency band parasite element and a upper frequency band parasite element. The resonance of the lower frequency of the parasite element is adjusted with the length of the ground contact. The lower resonance of the parasite element is a quarter-wave resonance. The resonance of the higher frequency is determined by the length of the parasite element (the longest dimension). The higher resonance is thus a half-wave resonance.

The resonance locations of the antenna arrangement according to the invention, and thus the available frequency ranges, are determined only by the distance between the supply point of the radiating elements and the supply point/short-circuit conductive strip of the parasite element and with the mechanical measurements of the short-circuit conductive strip.

The antenna structure according to the invention has two separate resonance locations on both frequency bands. The location of the lower resonance location is on both frequency bands determined by the parasite element according to the invention and the location of the upper resonance location is determined by the mechanical sizing of the radiating antenna element. The two separate resonance locations achieved with the antenna arrangement according to the invention provide a desired bandwidth in both utilised frequency ranges.

In the following, the invention will be described in detail. In the description, reference is made to the appended drawings, in which

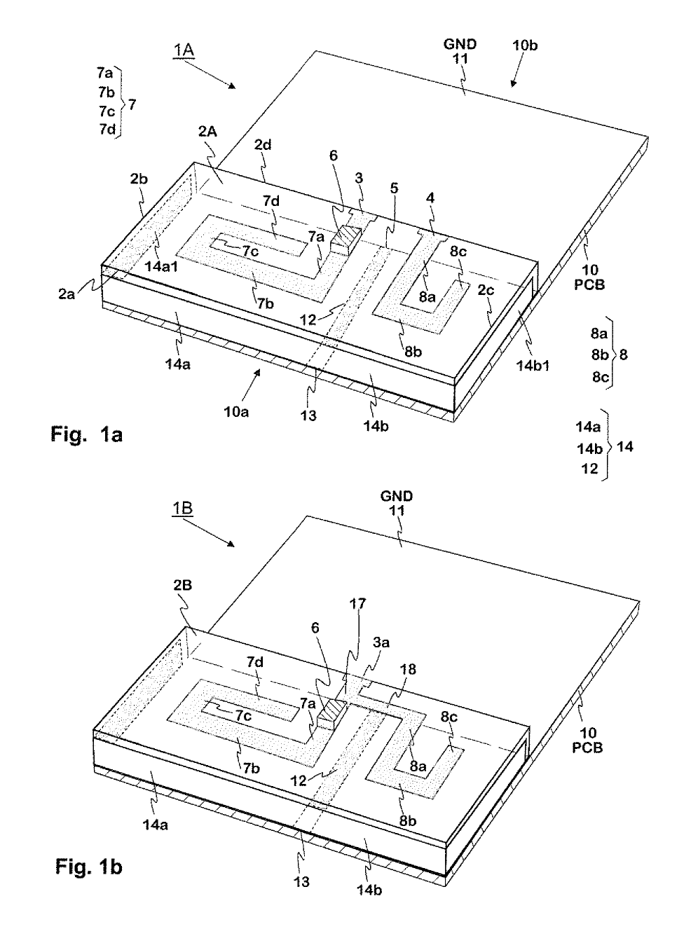

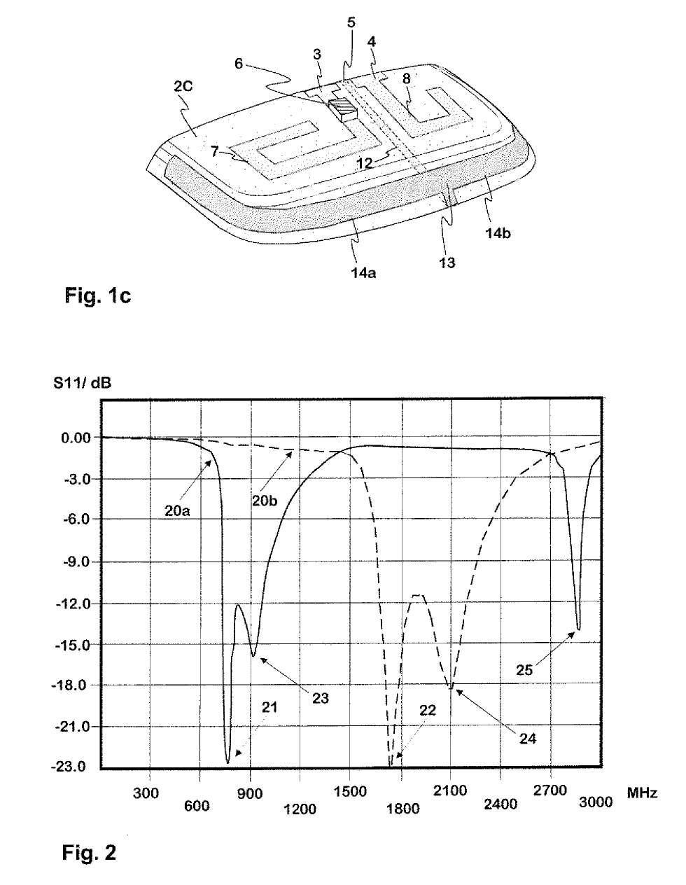

FIG. 1a shows as an example an antenna arrangement with two supply points according to the invention on a dielectric polyhedron,

FIG. 1b shows as an example an antenna arrangement with one supply point according to the invention on a dielectric polyhedron,

FIG. 1c shows as an example an antenna arrangement with two supply points according to the invention on an irregular dielectric piece,

FIG. 2 shows reflection attenuations of antennae measured from an antenna arrangement with two supply points,

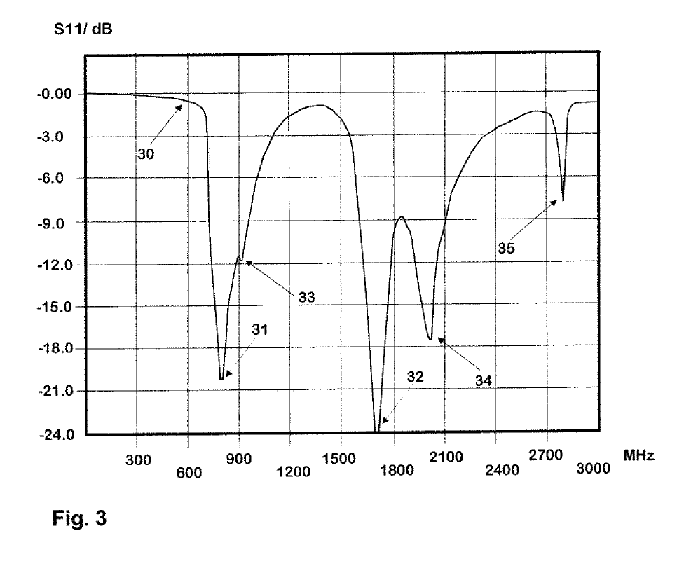

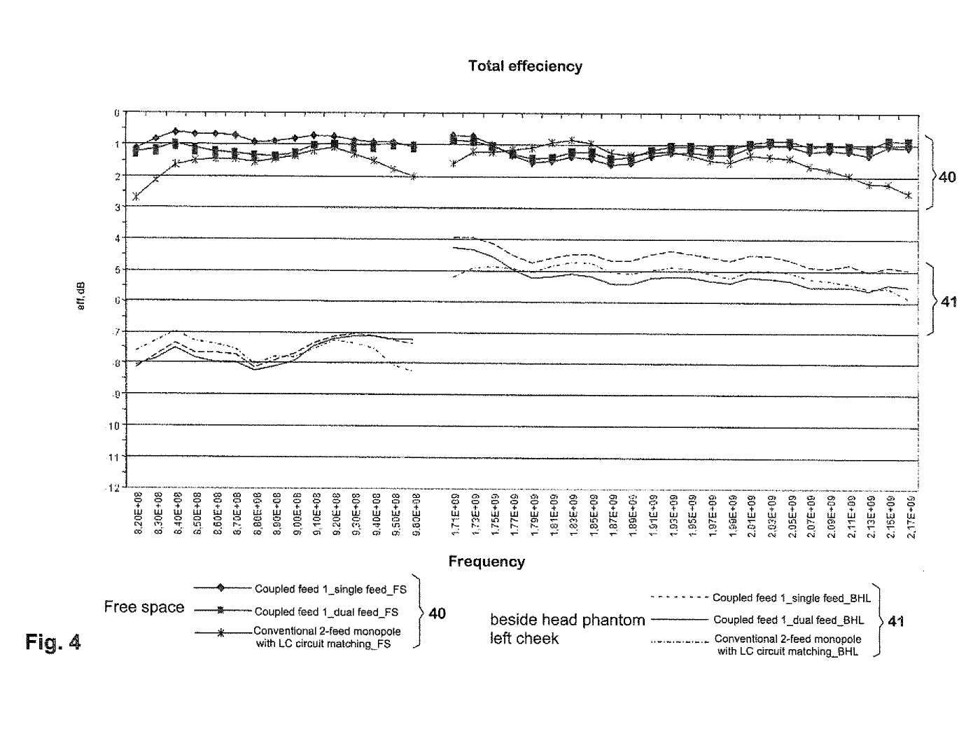

FIG. 3 shows reflection attenuation measured from an antenna arrangement with one supply point,

FIG. 4 shows the efficiency of an antenna arrangement according to the invention as measured in a free state and using an artificial head arrangement,

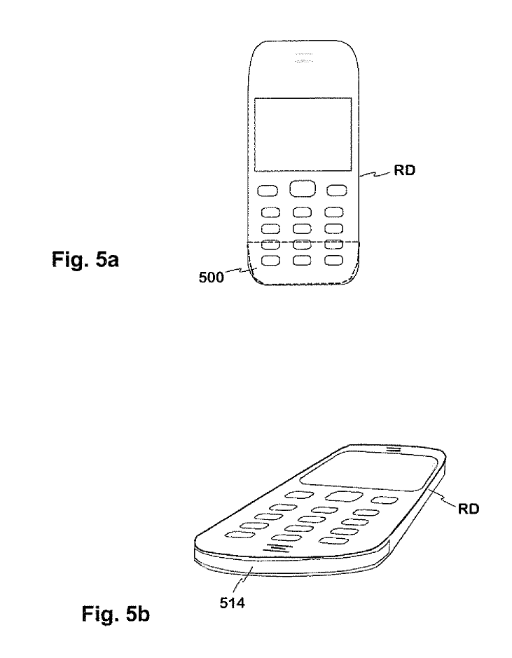

FIG. 5a shows an example of a radio device according to the invention,

FIG. 5b shows an example of a radio device, on the outer cover of which a parasite element forms a visible part

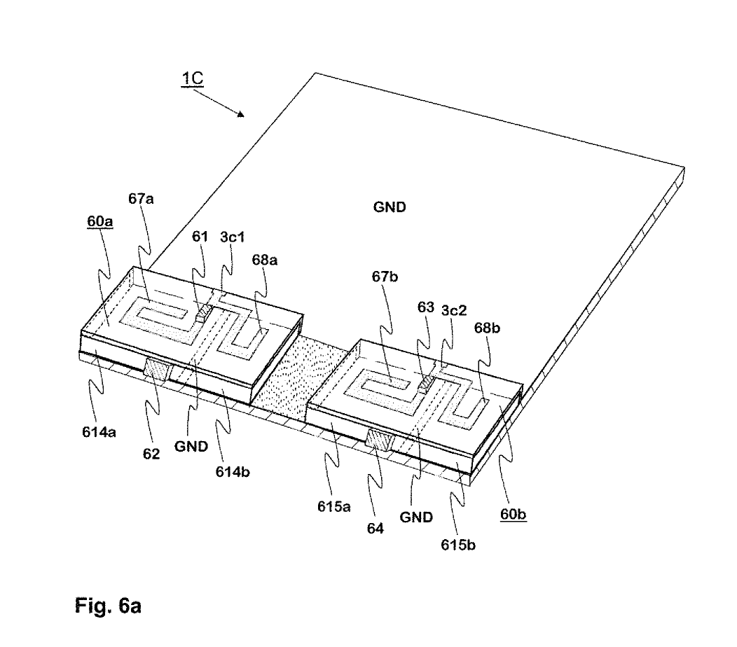

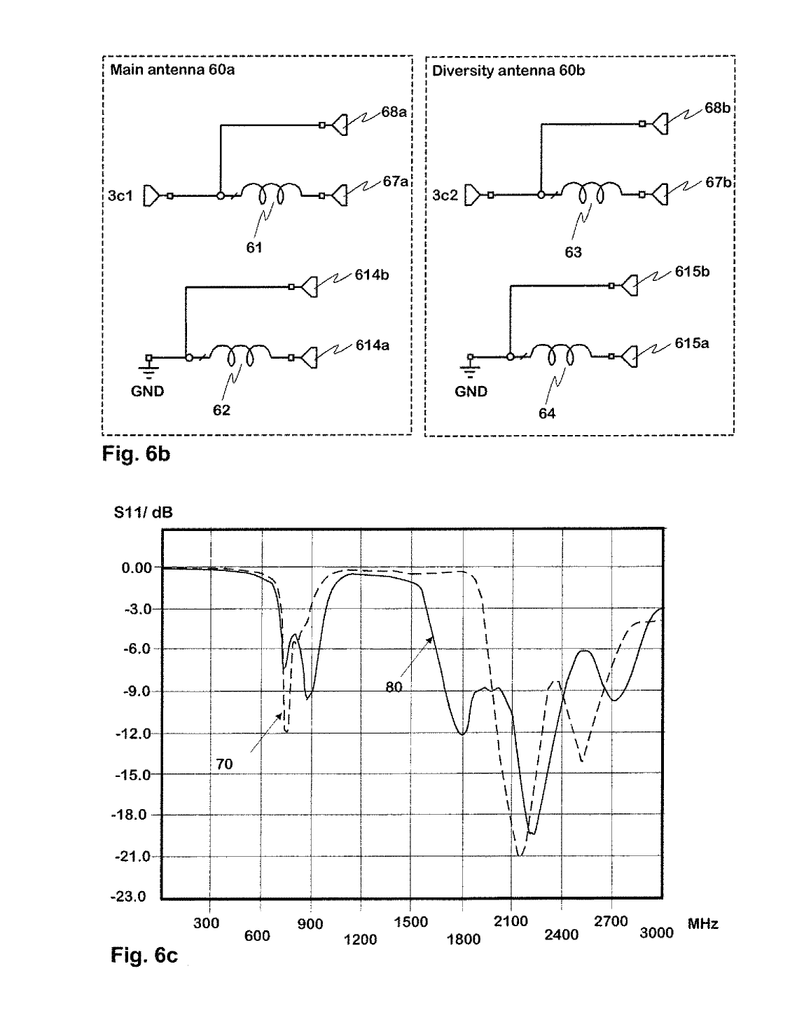

FIG. 6a shows as an example of an antenna arrangement where two antenna arrangements according to the invention form a diversity antenna system,

FIG. 6b shows the connecting diagram of the antenna arrangement of FIG. 6a, and

FIG. 6c shows reflection attenuations of the main antenna and the diversity antenna of FIG. 6b.

The embodiments in the following description are given as examples only, and someone skilled in the art may carry out the basic idea of the invention also in some other way than what is described in the description. Though the description may refer to a certain embodiment or embodiments in different places, this does not mean that the reference would be directed towards only one described embodiment or that the described characteristic would be usable only in one described embodiment. The individual characteristics of two or more embodiments may be combined and new embodiments of the invention may thus be provided.

FIGS. 1a and 1b show an antenna arrangement according to the invention, where a dielectric polyhedron is utilised. In the example in FIG. 1c the dielectric piece has one planar surface and the rest of the dielectric piece is made up of at least partly curved surfaces, which advantageously conform to the shapes of the cover of the data processing device.

FIG. 1a shows an example of an antenna arrangement 1A according to the invention, where the two monopole-type radiating elements 7 and 8 have their own supply point/antenna port, reference numbers 3 and 4, on the upper surface (radiating plane) of the antenna module 2A (polyhedron). The antenna arrangement 1A in FIG. 1a can advantageously be used as the antenna of a data processing device, which utilises two separate frequency bands. The used frequency bands may for example be 824-960 MHz and 1 710-2 170 MHz.

The data processing device comprises a planar circuit board 10 (PCB). The main part of the conductive upper surface 11 of the circuit board 10 can function as the ground plane (GND) of the data processing device. The circuit board 10 advantageously has a rectangular shape, which has a first end 10a and a second end 10b, which are parallel. The ground plane 11 extends from the second end 10b of the circuit board 10 to the grounding point 5 of the parasite element 14 of the antenna module comprised in the antenna arrangement 1A according to the invention. In the antenna arrangement 1A according to the invention the antenna module 2A to be used is installed in the first end 10a of the circuit board 10. The ground plane 11 has been removed from the first end 10a of the circuit board 10 at the part left underneath the antenna module 2A.

The antenna module 2A of the antenna arrangement 1A according to the invention is advantageously implemented on a dielectric polyhedron, all the faces of which are advantageously rectangles. Thus the opposite faces of the polyhedron are of the same shape and size. The outer dimensions of the polyhedron are advantageously the following. The long sides 2a and 2d of the polyhedron projected onto the level of the circuit board 10, which in FIG. 1a are in the direction of the first end 10a of the circuit board, advantageously have a length of about 50 mm. The short sides 2b and 2c of the polyhedron projected onto the level of the circuit board 10 are in the direction of the sides in the direction of the longitudinal axis of the circuit board 10. The short sides 2b and 2c of the polyhedron advantageously have a length of about 15 mm. The thickness of the polyhedron is advantageously about 5 mm.

The antenna module 2A is advantageously installed in the first end 10a of the circuit board 10. The ground plane 11 of the circuit board 10 is removed from the surface area of the first end 10a of the circuit board 10, which is left underneath the antenna module 2A when installed into place. Electronic components of the data processing device (not shown in FIG. 1a) are installed in the second end 10b of the circuit board 10.

In the example in FIG. 1a the exemplary parasite element 14 comprised in the antenna arrangement 1A according to the invention is implemented on three sides/surfaces 2a, 2b and 2c of the antenna module 2A, which are perpendicular to the level defined by the circuit board 10. The parasite element 14 is thus advantageously implemented on three surfaces of the antenna module 2A. The parasite element 14 advantageously has the shape of a flat-bottomed/sharp-angled U. The parasite element 14 is divided into two branches 14a and 14b. The branch 14a functions as the parasite element of the lower frequency range radiator 7. The branch 14b functions as the parasite element of the upper frequency range radiator 8.

The branches 14a and 14b of the parasite element 14 are connected together at the connection point 13 on the side 2a of the antenna module 2A. The connection point 3 of the branches 14a and 14b of the parasite element 14 is in the example of FIG. 1a closer to the shorter side 2c of the antenna module than to the side 2b. In the example of FIG. 1a the branches 14a and 14b of the parasite element 14 are conductive strips.

When the antenna module 2A is installed into place the branches 14a and 14b of the parasite element 14 are close to the outer edges of the first end 10a of the circuit board 10. Thus the bottom of the U of the parasite element 14 is substantially in the direction of the side (edge) 2a of the antenna module 2A and the end 10a of the circuit board 10. The first arm 14a1 of the U of the parasite element 14 is in the direction of the side 2b of the antenna module 2A. The second arm 14b1 of the U of the parasite element 14 is in the direction of the side 2c of the antenna module 2A. Thus the arms 14a1 and 14b1 of the parasite element 14 are directed toward the side 2d of the antenna module 2A and simultaneously toward the ground plane 11 of the circuit board 10. The arms 14a1 and 14b1 do however not extend so far that they would generate an electric contact to the ground plane 11 of the circuit board 10.

The conductive strip 12 of the parasite element 14, which short-circuits to the ground plane 11 of the circuit board 10, is connected to the ground plane 11 of the circuit board 10 at the grounding/connecting point 5. A conductive strip 12 in the direction of the longitudinal axis of the circuit board departs from the grounding point 5 toward the side 2a of the antenna module 2A, which conductive strip 12 is joined with the U-shaped parasite element 14 at the connecting point 13 of its branched 14a and 14b. The grounding point 5 of the conductive strip 12 and the ground plane 11 is situated at the ground plane 11 of the circuit board 10 close to the points, where the supply points 3 and 4 of the antenna element situated on the upper surface of the antenna module 2A can be projected onto the level of the circuit board. The distance between the connecting point 5 and the projections of the supply points 3 and/or 4 in the level defined by the circuit board 10 is advantageously in the range of 1-4 mm. This projected distance/distances and the length and width of the conductive strip 12 of the parasite element 14 short-circuiting to the ground plane 11 are used to determine the resonance frequency of the lower frequency band provided with the parasite element 14. The resonance location caused by the parasite element on the lower frequency band is a so-called quarter-wave resonance. This resonance location is hereafter called the first resonance of the lower frequency band.

The parasitic resonance location of the upper frequency band is determined by the total length of the parasite element 14. The resonance frequency on the upper frequency band is a so-called half-wave resonance location. This resonance location is hereafter called the first resonance of the upper frequency band.

The monopole-type radiators 7 and 8 of the antenna arrangement 1A are on the planar upper surface (radiating surface) of the antenna module 2A. The monopole-type radiators 7 and 8 are formed from conductive strips, the lengths of which are in the range of a quarter-wave in either of the frequency ranges used by the data processing device. The width of the conductive strips forming the radiators 7 and 8 is advantageously in the range of 0.5-3 mm.

The lower frequency range radiator 7 is supplied from the antenna port/supply point 3. The supply point 3 and the radiating element 7 are connected by a coil 6, the inductance of which is approximately 13 nH. The coil 6 is used to shorten the physical length of the lower frequency range radiator 7, whereby the surface area required by the radiator 7 is reduced. The lower frequency band radiator 7 advantageously comprises four conductive parts 7a, 7b, 7c and 7d, which make up the first conductor branch. The first conductive part 7a is in the direction of the longitudinal axis of the circuit board 10, and its starting point is the coil 6 and its direction is toward the longer side 2a of the antenna module 2A. Before the longer side 2a of the antenna module 2A it turns by 90° and is connected to the second conductive part 7b, which is in the direction of the side 2a of the antenna module 2A. The direction of the second conductive part is toward the side 2b of the antenna module 2A. The second conductive part 7b is connected to the third conductive part 7c before the side 2b of the antenna module 2A. At the connecting point a 90° turn occurs in the same direction as in the previous connecting point. The third conductive part 7c is in the direction of the side 2b of the antenna module 2A and it travels from the connecting point toward the side 2d of the antenna module 2A. The third conductive part 7c is connected to the fourth conductive part 7d before the side 2d of the antenna module 2A. At the connecting point a 90° turn occurs in the same direction as in the previous connecting points. From this connecting point the fourth conductive part 7d continues in the direction of the side 2d of the antenna module 2A toward the first conductive part 7a, however without reaching it. The total length of the radiator 7 and the coil 6 affecting the electric length of the radiator 7 generate a λ/4 resonance at the lower frequency range. This natural resonance location is hereafter called the upper resonance location of the lower frequency band.

The monopole-type radiator 8 of the upper frequency range is supplied from the supply point 4. The upper frequency band radiator 8 advantageously comprises three conductive parts 8a, 8b and 8c. The first conductive part 8a is in the direction of the longitudinal axis of the circuit board 10, and its starting point is the supply point 4 and its direction is toward the longer side 2a of the antenna module 2A. Before the side 2a of the antenna module 2A it is connected to the second conductive part 8b. In the connecting point a 90° turn occurs toward the side 2c of the antenna module 2A. Thus the second conductive part 8b is in the direction of the side 2a of the antenna module 2A. The second conductive part 8b is connected to the third conductive part 8c before the side 2c of the antenna module 2A. At the connecting point a 90° turn occurs in the same direction as in the previous connecting points. The third conductive part 8c is in the direction of the side 2c of the antenna module 2A and it continues from the connecting point toward the side 2d of the antenna module 2A, however without reaching it. The total length of the radiator 8 generates a λ/4 resonance on the upper frequency range used by the data processing device. This natural resonance location is hereafter called the upper resonance location of the upper frequency band.

The tuning of the antenna arrangement 1A according to FIG. 1a to two frequency bands is implemented as follows. The resonance location provided by the parasite element 14 on the lower frequency band is defined by the mechanical dimensions of the conductive strip 12 and by the projected distances of the connecting point 5 and the supply points 3 and 4 of the antenna radiators 7 and 8 on the level of the circuit board 10. In the antenna arrangement 1A according to the invention the location of the connecting point 5 in relation to the location of the supply points 3 and/or 4 on the level defined by the circuit board 10 and the length and width (i.e. inductance) of the conductive strip 12 of the parasite element 14 short-circuiting to the ground plane define the first resonance location generated by the parasite element 14 on the lower frequency range. The resonance is a so-called quarter-wave resonance location. The location of the first resonance location of the upper frequency range is defined by the total length of the parasite element 14, and it is a so-called half-wave resonance location.

The second resonance location (λ/4 resonance) of the antenna arrangement 1A is generated on the lower frequency band at a frequency defined by the length of the monopole-type radiator 7 and the coil 6. The second resonance location (λ/4 resonance) of the upper frequency band is defined by the length of the monopole-type radiator 8.

FIG. 1b shows an example of an antenna arrangement 1B according to a second embodiment of the invention, where the monopole-type radiating elements 7 and 8 have a shared supply point/antenna port 3a on the upper surface of the antenna module 2B.

In this embodiment the circuit board 10, the antenna module 2B installed on the circuit board and the parasite element 14 otherwise correspond to the corresponding structures in the embodiment of FIG. 1a. Also the location of the lower frequency range radiator 7 and its mechanical dimensions correspond to the embodiment presented in FIG. 1a.

In the embodiment of FIG. 1b there is only one supply point/antenna port 3a. The mechanical elements of the lower frequency range monopole-type radiator 7 are connected to the supply point 3a through the coil 6. The upper frequency range monopole-type radiator 8 is connected to the supply point 3a by means of a connection conductor 18, which is connected to the supply point at the point 17.

The tuning of the antenna arrangement 1B according to FIG. 1b to two frequency bands is implemented as follows. The first resonance location provided by the parasite element 14 on the lower frequency band is defined by the mechanical dimensions of the conductive strip 12 and by the distance between the connecting point 5 and the point projected by the supply point 3a of the antenna radiators 7 and 8 on the level of the circuit board 10. In the antenna arrangement 1B according to the invention the location of the connecting point 5 in relation to the projected location of the supply point 3a on the level defined by the circuit board 10 and the length and width (i.e. inductance) of the conductive strip 12 of the parasite element 14 short-circuiting to the ground plane define the first resonance location generated by the parasite element 14 on the lower frequency range. The resonance is a so-called quarter-wave resonance location. The location of the first resonance location of the upper frequency range is defined by the total length of the parasite element 14, and it is a so-called half-wave resonance location.

In the examples of FIGS. 1a and 1b the parasite element 14 is so long compared to the width of the radio device that it extends onto three sides 2a, 2b and 2c of the antenna module 2A or 2B. Still, if the outer dimensions of the radio device change so that the width of the radio device increases, then the parasite element 14 can be either on the end side 2a and the side 2c or only on the end side 2a. In all situations, the resonance frequencies of the parasite element 14 are determined in the above-described manner.

The second resonance location (λ/4 resonance) of the antenna arrangement 1B is generated on the lower frequency band at a frequency defined by the length of the monopole-type radiator 7 and the coil 6. The second resonance location (λ/4 resonance) of the upper frequency band is defined by the mechanical dimensions of the monopole-type radiator 8.

The technical advantage of the embodiments shown in FIGS. 1a and 1b is that both the lower and the upper frequency range can be sized with mechanical sizing and positioning of the antenna elements according to the invention. Thus no adaptation connecting implemented with discrete components is needed on the circuit board 10.

It is also a technical advantage of the embodiments of FIGS. 1a and 1b that antenna arrangements utilising a shared supply point or two antenna-specific supply points are structurally identical except for the supply point. Both supply methods provide desired properties both on the lower and the upper frequency band.

FIG. 1c shows an example of an antenna arrangement according to the invention, which is implemented on the surface of a partly irregular dielectric piece. FIG. 1c does not show the circuit board, onto which the antenna module 2C is installed. The two monopole-type radiating elements 7 and 8 shown in FIG. 1c have their own supply points/antenna ports, references 3 and 4, on the upper surface of the antenna module 2C. The branches 14a and 14b of the parasite element 14 are implemented on the at least partly curved side surfaces of the dielectric piece. The short-circuit conductor 12 of the parasite element 14 departs from the short-circuit point 5 and advances in the direction of the longitudinal axis of the circuit board functioning as an installation base on the substantially planar lower surface of the antenna module 2C toward the first end of the circuit board. At the outer edge of the antenna module 2C the short-circuit conductor 5 turns to the end surface of the antenna module 2C, where it is connected to the parasite element at the connection point 13 of the branches of the parasite element.

An antenna module with one supply point according to FIG. 1b can also be implemented in the same manner.

FIG. 2 shows an example of a reflection attenuation measurement of the antenna component 1A according to the first embodiment of the invention. In this embodiment both radiators have their own separate supply point 3 and 4. FIG. 2 shows with a continuous line 20a the reflection coefficient S11 measured from the supply point/antenna port 3 of the lower frequency band radiator 7 as decibels as a function of the frequency in the range 0-3 000 MHz. The same figure shows with a dotted line 20b the reflection coefficient S11 measured from the supply point 4 of the upper frequency band radiator 8 as decibels as a function of the frequency in the range 0-3 000.

The continuous line 20a depicts the reflection attenuation measured from the supply point 3 of the lower frequency range radiator 7. Reference 21 shows a visible first resonance location provided by the branch 14a of the parasite element 14 in the reflection attenuation curve. Reference 23 shows a second resonance provided by the radiator 7 and coil 6 in the lower frequency band. The reflection attenuation measured from the supply point 3 of the lower frequency range radiator 7 is at least −12 dB in the frequency range 824-960 MHz. The reflection attenuation both in the lower limit frequency 824 MHz and in the upper limit frequency 960 MHz is −14 dB.

In the upper frequency range radiator's 8 frequency range 1 710-2 170 MHz the lower frequency range antenna signal is attenuated by at least 13 dB. The first and second resonance location obtained with the antenna arrangement according to the invention provide a sufficient bandwidth in the lower utilised frequency band 824-960 MHz and a sufficient attenuation in the upper utilised frequency band 1 710-2 170 MHz.

The dotted line 20b depicts the reflection attenuation measured from the supply point 4 of the upper frequency range radiator 8. Reference 22 shows a first resonance location provided by the branch 14b of the parasite element 14 in the upper frequency band. Reference 24 shows the second resonance location provided by the radiator 8 in the upper frequency band. Reference 25 shows a multiple of the resonance of the parasite element 14a of the lower frequency range, which multiple is not in the utilised frequency range.

The reflection attenuation measured from the supply point 4 of the upper frequency range radiator 8 is at least −11 dB in the frequency range 1 710-2 170 MHz. The reflection attenuation both in the lower limit frequency 1 710 MHz and in the upper limit frequency 2 170 MHz is −14 dB. In the lower frequency range radiator's 7 frequency range 824-960 MHz the upper frequency range signal is attenuated by at least 13 dB. The first and second resonance location obtained with the antenna arrangement according to the invention provide a sufficient bandwidth also in the upper utilised frequency band 1 710-2 170 MHz and a sufficient attenuation in the lower utilised frequency band 824-960 MHz.

FIG. 3 shows an example of a reflection attenuation measurement of the antenna component 1B according to the second embodiment of the invention. In this embodiment both monopole-type radiators 7 and 8 have a shared supply point/antenna port 3a. FIG. 3 shows with a continuous line 30 the reflection coefficient S11 measured from the supply point 3a as decibels as a function of the frequency in the range 0-3 000 MHz.

Reference 31 shows a visible first resonance location provided by the branch 14a of the parasite element 14 in the reflection attenuation curve in the lower utilised frequency range. Reference 33 shows a second resonance provided by the radiator 7 and coil 6 in the lower frequency range. The reflection attenuation measured from the supply point 3a of the lower frequency range radiator 7 is at least −10.5 dB in the frequency range 824-960 MHz. The reflection attenuation at the lower limit frequency 824 MHz is −16 dB and at the upper limit frequency 960 MHz it is −10.5 dB.

Reference 32 shows a first resonance location provided by the branch 14b of the parasite element 14 in the upper utilised frequency range. Reference 34 shows the second resonance location provided by the radiator 8 in the upper frequency range. Reference 35 shows a multiple of the resonance of the parasite element 14a of the lower frequency range, which multiple is not in the utilised frequency range.

The reflection attenuation measured from the supply point 3a is in the upper frequency range 1 710-2 170 at least −9 dB. The reflection attenuation at the lower limit frequency 1 710 MHz is −18 dB and at the upper limit frequency 2 170 MHz it is −12 dB.

FIG. 4 shows the measured total efficiency of the antenna arrangements 1A and 1B according to FIGS. 1a and 1b. Additionally FIG. 4 shows comparative measurements of measurement results of a circuit solution implemented with discrete components. The results of reference 40 of FIG. 4 depict the total efficiency measured in a free state both in the lower and upper frequency range. The results on reference 41 of FIG. 4 depict the total efficiency when an artificial head arrangement is used in the measuring.

From the curves of reference 40 it can be seen that both antenna arrangements 1A and 1B according to the invention have a better efficiency than a comparative arrangement in the lower and upper edge of both utilised frequency ranges when measured in a free state. In the middle parts of the lower and upper frequency range the antenna arrangements 1A and 1B according to the invention correspond with regards to their performance to the performance of an adaptation circuit connected from discrete components.

From the curves of reference 41 it can be seen that both antenna arrangements 1A and 1B according to the invention have quite the same efficiency as a comparative arrangement in the lower and upper edge of both frequency ranges, when the measurements are performed using artificial head measuring.

FIG. 5a shows an example of a data processing device according to the invention, which is a radio device RD. In the radio device RD has in the figure with a dotted line been shown the internal antenna module 500 as described above, which is installed on the circuit board of the radio device. The radio device RD is advantageously a mobile phone functioning on two or more frequencies.

FIG. 5b shows a second example of a radio device RD according to the invention. When the antenna module 500 of the radio device is installed in place, the parasite element 514 of the antenna module according to the invention is a part of the outer cover of the radio device. It can be utilised for example when designing the appearance of the device. In the example in FIG. 5b the antenna module 500 according to the invention is installed in the first end of the radio device RD, where the microphone of the radio device is located. Thus the bottom of the parasite element 14 is a part of the first end of the radio device. The branches of the U of the parasite element are on the two sides in the direction of the longitudinal axis of the radio device. Thus the branches of the U of the parasite element point from the first end of the radio device, which end includes a microphone, toward the second end of the radio device.

In the examples in FIGS. 5a and 5b the antenna module 500 according to the invention is installed in the end of the radio device, where the microphone of the device is located. This type of antenna should be placed in the microphone end of the device, because there is no ground plane or other metal surface decreasing connection to the user's head underneath the radiator.

FIG. 6a shows an example of a diversity antenna arrangement 1C according to a third embodiment of the invention. The diversity antenna comprises two antenna modules, a main antenna module 60a and a diversity antenna module 60b, that are mounted parallel at the same end of a PCB board. The antenna modules installed on the circuit board and the parasite elements otherwise correspond to the corresponding radiator structures in the embodiment of FIG. 1b. Also the location of the parasitic radiator on both the main antenna module and the diversity antenna module corresponds to the location of the embodiment depicted in FIG. 1b.

The main antenna module 60a comprises two monopole-type radiating elements 67a and 68a that have a shared supply point/antenna port 3c1 on the upper surface of the antenna module 60a, The electrical length of the radiating element 67a has been lengthened by a coil 61. The parasitic radiator comprises also two branches 614a and 614b. The electrical length of the branch 614a that is near the radiating element 67a has been lengthened by a coil 62.

Also the diversity antenna module 60b comprises monopole-type radiating elements 67b and 68b that have a shared supply point/antenna port 3c2 on the upper surface of the antenna module 60b. The electrical length of the radiating element 67b has been lengthened by a coil 63. The parasitic radiator comprises also two branches 615a and 615b. The electrical length of the branch 615a that is near the radiating element 67b has been lengthen by a coil 64.

FIG. 6b shows as a circuit diagram one exemplary embodiment of a diversity antenna arrangement 1C according to a third embodiment of the invention.

The input 3c1 of the main antenna component 60a is connected to both monopole-type radiators 67a and 68a. The electrical length of the monopole-type radiator 67a has been lengthened by coil 61 that has an inductance of 18 nH. The parasitic radiator input GND is connected to both branches 614a and 614b of the parasitic radiator. The electrical length of the branch 614a has been lengthened by coil 62 that has an inductance of 22 nH.

The input 3c2 of the diversity antenna component 60b is connected to both monopole-type radiators 67b and 68b. The electrical length of the monopole-type radiator 67b has been lengthened by coil 63 that has an inductance of 27 nH. The parasitic radiator input GND is connected to both branches 615a and 615b of the parasitic radiator. The electrical length of the branch 615a has been lengthened by coil 64 that has an inductance of 33 nH.

FIG. 6c shows an example of a reflection attenuation measurement of the antenna component 1C according to the third embodiment of the invention. In this embodiment the main antenna component 60a and diversity antenna component 60b are mounted parallel at the same end of the PCB board. FIG. 6c shows with a continuous line 80 the reflection coefficient S11 measured from the supply point 3c1 of the main antenna component in decibels as a function of the frequency in the range of 0-3 000 MHz. With a dotted line 70 is depicted the reflection coefficient S11 measured from the supply point 3c2 of the diversity antenna component in decibels as a function of the frequency in the range of 0-3 000 MHz.

It can be seen in FIG. 6c that the diversity antenna system fulfils −6 dB return loss requirement in frequency ranges 869-960 MHz and 1 850-2 690 MHz.

Some advantageous embodiments of the antenna component according to the invention have been described above. The invention is not limited to the solutions described above, but the inventive idea can be applied in numerous ways within the scope of the claims.

1.-16. (canceled)

17. A multiband antenna for use in a radio device, comprising:
a circuit board comprising a ground plane disposed on a first portion of the circuit board, the circuit board further comprising a second portion on which the ground plane is not disposed;
a dielectric component disposed on the second portion of the circuit board;
a first and a second radiating element resident on an upper surface of the dielectric component, the first and the second radiating elements configured to radiate at a lower and an upper frequency band, respectively; and
a parasitic element disposed on a plurality surfaces of the dielectric component that are perpendicular to the ground plane of the circuit board.

18. The multiband antenna of claim 17, wherein the first radiating element of the lower frequency band is configured to be supplied from a first supply point coupled to an antenna port of the radio device; and
wherein the second radiating element of the upper frequency band is configured to be supplied from a second supply point coupled to the antenna port.

19. The multiband antenna of claim 18, wherein the parasitic elements are configured to widen the respective lower and upper frequency bands associated with the first and second radiating elements, respectively.

20. A multiband antenna for use in a radio device, comprising:
a circuit board comprising a ground plane;
a dielectric piece that is installed on a first end of the circuit board, the first end of the circuit board having the ground plane removed;
first and second monopole-type elements resident on an upper surface of the dielectric piece that radiate in separate frequency bands, the first and second monopole-type elements corresponding to lower and upper frequency bands, respectively;
a parasitic element that is electromagnetically coupled to the first and second monopole-type elements on at least one surface of the dielectric piece.

21. The antenna of claim 20, wherein:
the first monopole-type element of the lower frequency band is arranged to be supplied from a first supply point connected from an antenna port, the first monopole-type element together with other portions of the multiband antenna comprising a first resonator, the natural frequency of the first resonator being in said lower frequency band;
the second monopole-type element of the upper frequency band is arranged to be supplied from a second supply point connected from the antenna port, the second monopole-type element together with other portions of the multiband antenna comprising a second resonator, the natural frequency of the second resonator being in said upper frequency band.

22. The antenna of claim 21, wherein:
the parasitic element is grounded from a connecting point to the ground plane of the circuit board, the parasite element in combination with the other portions of the multiband antenna comprising a third resonator; and
both the lower frequency band and the upper frequency band have two resonance locations in order to widen their respective frequency bands, the resonance location associated with the lower frequency band being caused by the parasitic element and the resonance location associated with the upper frequency band being caused by the first and second monopole-type elements.

23. The multiband antenna of claim 20, wherein:
the electromagnetic coupling between the first and second monopole-type elements and the parasite element is formed at least in part by a predominantly inductive connection of a conductive strip departing from the connecting point of the parasitic element and the first and second monopole-type elements; and
the magnitude of the predominantly inductive connection being determined at least in part by a distance between the first and second supply points and the connecting point of the parasite element.

24. A multi-band antenna configured for use in a radio device, comprising:
a dielectric piece, which has a first surface;
a first and a second monopole-type elements that radiate on a lower and an upper band, respectively, with their supply points being resident on a second surface of the dielectric piece, the second surface being substantially parallel to the first surface;
a parasitic element on at least one surface of the dielectric piece, the parasitic element forming an angle in relation to the first and the second surface;
wherein the multi-band antenna is configured to provide on both the lower band and the upper band two resonance locations in order to widen the frequency range of the lower and upper bands; and
wherein the resonance of the lower functional band is caused by the parasitic element and the resonance of the upper band is the natural resonance of the first and the second monopole-type elements.

25. The multi-band antenna of claim 24, wherein the first monopole-type element of the lower band comprises a supply point on a first side of the multi-band antenna, a coil and a quarter-wave radiator comprising four conductor branches connected to the coil.

26. The multi-band antenna of claim 25, wherein the coil is configured to at least shorten the physical length of the first monopole-type element.

27. The multi-band antenna of claim 25, wherein the dielectric piece comprises a rectangular polyhedron.

28. The multi-band antenna of claim 27, wherein the second monopole-type element of the upper band comprises a supply point on the first side of the multi-band antenna and a quarter-wave radiator comprising three subsequent conductor branches in electrical communication with the supply point.

29. The multi-band antenna of claim 25, wherein the second monopole-type element of the upper band comprises a supply point on the first side of the multi-band antenna and a quarter-wave radiator comprising three subsequent conductor branches in communication with the supply point.

30. The multi-band antenna of claim 29, wherein the second monopole-type element of the upper band and the first monopole-type element of the lower band have a shared supply point on the first side of the multi-band antenna.

31. The multi-band antenna of claim 24, wherein the parasitic element comprises a U-shape, a bottom part of the U-shape being situated at an end side of the multi-band antenna, and one or more adjacent sides of the U-shape being situated in the direction of the longitudinal axis of the radio device.

32. The multi-band antenna of claim 31, wherein the parasitic element is divided at a connection point of a short-circuit conductor into a first branch and a second branch.

33. The multi-band antenna of claim 32, wherein the first and second branches of the parasitic element are disposed on a third and a fourth side of the multi-band antenna.

34. The multi-band antenna of claim 33, wherein a first resonance frequency of the lower band is defined by the length of the short-circuit conductor, and a second resonance frequency of the upper band is defined by the total length of the parasitic element.

35. The multi-band antenna of claim 34, wherein the first resonance of the lower band comprises a quarter-wave resonance, and the first resonance of the upper band comprises a half-wave resonance.

36. A radio device (RD), comprising:
at least one internal multi-band antenna having at least a first and a second functional band, said at least one internal multi-band antenna comprising a first monopole-type element configured to radiate on a lower frequency band and a second monopole-type element configured to radiate on an upper frequency band;
a parasite element electromagnetically coupled to the first and second monopole-type elements, the first and second monopole-type elements are coupled to one or more supply points connected to an antenna port of the radio device, said parasite element being coupled from a first short-circuit point to a ground plane of the radio device;
wherein the first monopole-type radiating element of the lower frequency band is arranged to be supplied from the at least one supply point connected to the antenna port, the first monopole-type radiating element together with the other parts of the multi-band antenna comprising a first resonator, the natural frequency of the first resonator being in said lower frequency band;
wherein the second monopole-type radiating element of the upper frequency band is arranged to be supplied from the at least one supply point connected to the antenna port, the second monopole-type radiating element comprises a second resonator, the natural frequency of the second resonator being in said upper frequency band;
wherein the parasite element is grounded only from a connecting point to the ground plane of the circuit board, the parasite element together with the surrounding antenna parts comprising a third resonator; and
wherein both the lower frequency band and the upper frequency band have two resonance locations in order to widen the functional band, the resonance associated with the lower frequency band being caused by the parasite element and the resonance associated with the higher frequency band being caused by the first and second monopole-type elements.

37. The radio device of claim 36, wherein the parasite element comprises a U-shape, the bottom part of the U is on the side constituting a first outer end of the radio device and the parasite element is divided at a connection point of a short-circuit conductor into a first branch and a second branch, the arms of the branches of the parasite element being on a third and a fourth side of the radio device.

38. The radio device of claim 36, wherein the internal multi-band antenna comprises two parallel mounted multiband antenna components configured to comprise a diversity antenna system.
